(19) United States
(12) Patent Application Publication
(10) Pub. No.: US 2006/0143209 A1
(43) Pub. Date: Jun. 29, 2006

(54) Remote management of a computer system

(76) Inventors: Vincent J. Zimmer, Federal Way, WA (US); Michael A. Rothman, Puyallup, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,354

(22) Filed: Dec. 29, 2004

(51) Int. Cl. G06F 17/00; G06F 7/00

(52) U.S. Cl. 707/101

(57) ABSTRACT

Remote management of a computer system. A managed system change request is received at an out-of-band management controller of a computer system. The managed system change request is posted to a mailbox. The posting of the managed system change request to the mailbox is signaled. The computer system is modified based on the managed system change request without complicity from an operating system of the computer system.

### BACKGROUND

1. Field

Embodiments of the invention relate to the field of computer systems and more specifically, but not exclusively, to remote management of a computer system.

2. Background Information

System administrators manage various aspects of computer systems in an enterprise network. Such aspects include security, database control, and power management. Today's enterprise management systems do not have a process to convey management policy to managed systems without implicating the operating systems of the managed systems.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating one embodiment of an environment to support remote management of a computer system in accordance with the teachings of the present invention.

FIG. 2 is a block diagram illustrating one embodiment of an environment to support remote management of a computer system in accordance with the teachings of the present invention.

FIG. 3 is a flowchart illustrating one embodiment of the logic and operations to provide remote management of a computer system in accordance with the teachings of the present invention.

FIG. 4 is a block diagram illustrating one embodiment of an environment to support remote management of a computer system in accordance with the teachings of the present invention.

FIG. 5 is a block diagram illustrating one embodiment of an environment to support remote management of a computer system in accordance with the teachings of the present invention.

FIG. 6 is a block diagram illustrating one embodiment of an environment to support remote management of a computer system in accordance with the teachings of the present invention.

FIG. 7 is a block diagram illustrating one embodiment of an environment to support remote management of a computer system in accordance with the teachings of the present invention.

FIG. 8 is a block diagram illustrating one embodiment of a computer system to support remote management of a computer system in accordance with the teachings of the present invention

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

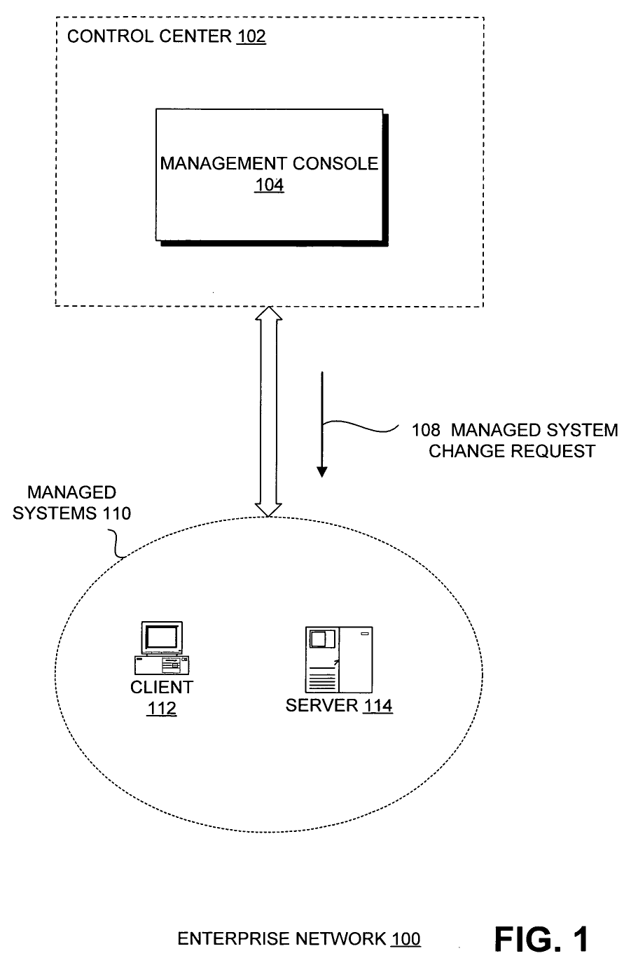

Turning to FIG. 1, an embodiment of an enterprise network 100 is shown. Enterprise network 100 includes one or more Local Area Networks (LAN), Wide Area Networks (WAN), Metropolitan Area Networks (MAN), an Intranet, an Internet, or any combination thereof. In general, an enterprise is an organization that utilizes computer systems. Such organizations include, but are not limited to, corporations, small businesses, non-profit institutions, government bodies, or the like. Enterprise network 100 includes a control center 102 connected to managed systems 110. Managed systems 110 include one or more computer systems managed by control center 102. While embodiments herein are described in relation to an enterprise network, it will be appreciated the embodiments of the invention may be implemented in other networked systems.

Control center 102 includes a management console 104. Management console 104 enables control center 102 to issue management policy to managed systems 110. Management console 104 may issue management policy using a managed system change request 108. Managed system change request 108 may be addressed to one or more managed systems 110.

Embodiments described herein may be used to provide an enterprise-wide policy to managed systems without complicity from the operating systems of the managed systems. In one embodiment, the management policy may be received at an out-of-band management controller and acted upon on each managed system at the firmware level. Embodiments herein provide for the management policy to affect processor specific settings of a processor of a managed system.

As described further below, the firmware level (also referred to as the firmware environment) is an operational environment between the operating system (OS) level and the hardware level of a computer system. Also, as used herein, the pre-boot phase of a computer system is generally defined as the firmware that runs between the processor reset and the Operating System (OS) loader. At the start of pre-boot, it is up to the code in the firmware to initialize the system to the point that an operating system can take over. The start of the OS load begins the period commonly referred to as OS runtime. During OS runtime, the firmware may act as an interface between software and hardware components of a computer system as well as perform other system tasks.

In one embodiment, managed systems 110 include one or more clients 112. For example, clients 112 may include systems of an enterprise at a university campus. In one embodiment, control center 102 may issue power management policy to reduce power consumption during low use times.

In another embodiment, managed systems 110 include one or more servers 114. For example, a web search engine may use one or more servers. These servers may be grouped into server farms around the country. In one embodiment, during off-peak usage times, some or all of the servers 114 may be placed in a low power-usage setting.

Embodiments of the present invention may be used to convey power management policy to the managed systems. Power consumption and cooling issues are constant challenges for enterprise systems. Hundreds or thousands of systems can add up to high utility costs for an organization. In the case of power consumption, the performance of a system is balanced against the amount of power the system consumes. Generally, the higher the frequency of a processor, the more power that is used by the processor.

Further, energy is needed to run cooling systems to control the thermal energy given off by managed systems. In general, a reduction in power consumption also leads to a decrease in the amount of thermal energy given off by a computer system. This lowering of thermal energy results in less power needed for cooling systems. In an embodiment of client computers, the cooling system may involve running a cooling fan at lower speeds or less often. In an embodiment of servers, the power costs of running sophisticated air-conditioning and cooling systems may be reduced.

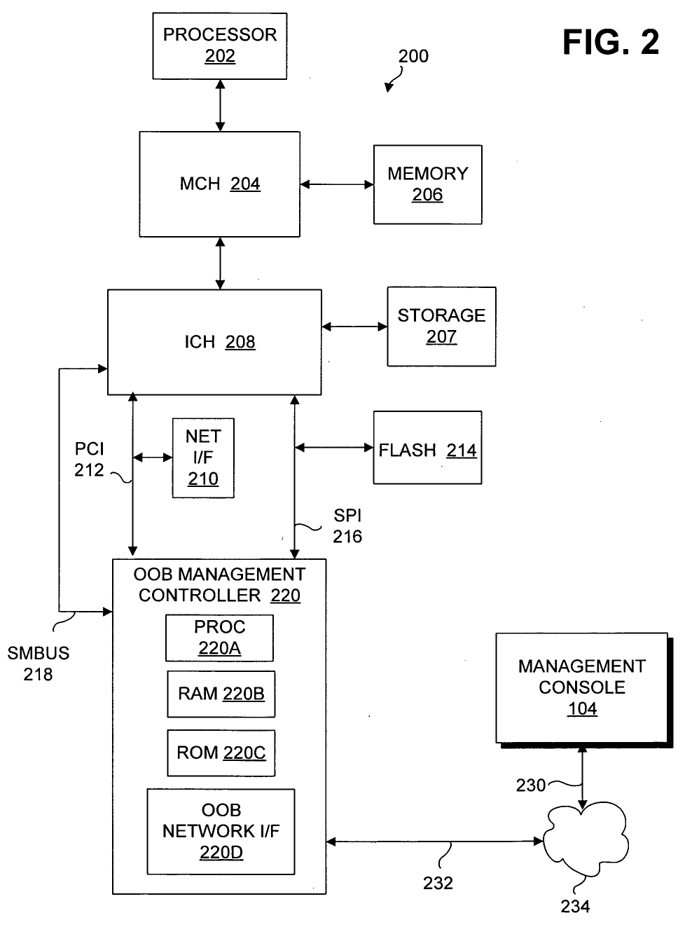

Turning to FIG. 2, an embodiment of a managed system 200 is shown. Managed system 200 is coupled to a network 234 by connection 232. Management console 104 is coupled to network 234 via connection 230. Connections 230 and 232 include direct connections, such as electrical and optical connections, wireless connections, or any combination thereof.

Managed system 200 includes an Input/Output (I/O) Controller Hub (ICH) 208 coupled to a Memory Controller Hub (MCH) 204. In one embodiment, ICH 208 serves as an I/O controller and MCH 204 serves as a memory controller.

A processor 202 and memory 206 are coupled to MCH 204. Processor 202 may include one or more processors for executing instructions for system 200. In one embodiment, processor 202 includes a Central Processing Unit (CPU). In alternative embodiments, other processors of managed system 200 may be affected by management policy as described herein, such as graphic controller processors, Redundant Array of Inexpensive Disks (RAID) controller processors, or the like.

Storage 207 is coupled to ICH 208. In one embodiment, storage 207 includes a hard disk drive coupled to ICH 208 using an Advanced Technology Attachment (ATA) interface. Other storage devices, such as a floppy disk drive, an optical disk drive, or the like, may also be coupled to ICH 208.

A System Management Bus (SMBUS) 218, a Peripheral Component Interface (PCI) bus 212, and a Serial Peripheral Interface (SPI) 216, or any combination thereof may be coupled to ICH 208. PCI bus 212 may include PCI-X, PCI Express, or the like.

In one embodiment, a network interface (I/F) 210 may be coupled to PCI bus 212. Network interface 210 is used to send and receive in-band communications. Embodiments of network I/F 210 include a Network Interface Card (NIC), a modem, or the like.

Managed system 200 may include a Flash memory 214 coupled to SPI 216. In one embodiment, Flash memory 214 has stored a system Basic Input/Output System (BIOS) for managed system 200. In alternative embodiments, other types of non-volatile storage, such as Read-Only Memory (ROM), may be used in place of or in conjunction with Flash memory 214. In one embodiment, instructions for receiving and acting on management policy according to embodiments described herein are stored in Flash memory 214.

Managed system 200 may also include an out-of-band (OOB) management controller 220. OOB management controller 220 may be coupled to ICH 208 by SMBUS 218, PCI 212, SPI 216, or any combination thereof. In one embodiment, OOB management controller 220 is coupled to the same motherboard as processor 202. OOB management controller 220 may be used to send and receive OOB communications for system 200. Such communications may include management information from management console 104.

OOB management controller 220 may include a processor 220A for executing instructions provided to controller 220. Controller 220 may include Random Access Memory (RAM) 220B and Read-Only Memory (ROM) 220C coupled to processor 220A by a bus (not shown). In one embodiment, ROM 220C has stored instructions for providing an enterprise management policy to managed system 200 according to embodiments herein.

In one embodiment, OOB management controller 220 may include an OOB network interface (I/F) 220D for communicating over network 234. Controller 220 may communicate over network 234 during the pre-boot phase and OS runtime of managed system 200. In one embodiment, OOB network I/F 220D includes an Ethernet compatible connection.

OOB management controller 220 may be used to access and manage managed system 200 by management console 104. In one embodiment, controller 220 and its network capabilities are not known to the user, but controller 220 is used in the background during pre-boot and runtime phases of managed system 200 by a system administrator, or the like.

In one embodiment, controller 220 is initialized at the beginning of startup of managed system 200. In this particular embodiment, the firmware may initialize the controller 220 when processor 202 is initialized. In this way, controller 220 is running and active before the firmware continues to more initializing tasks. Thus, controller 220 may send and receive network communications using OOB network I/F 220D and may execute instructions using processor 220A during pre-boot of managed system 200.

In another embodiment, controller 220 is active during a standby power state, such as a sleep state, of managed system 200. Thus, when managed system 200 is awakened, controller 220 is available immediately.

In one embodiment, OOB management controller 220 may have access to various platform devices during pre-boot as well as OS runtime. In one embodiment, controller 220 has access to SMBUS 218 that enables controller 220 to issue a System Management Interrupt (SMI) during pre-boot as well as operating system runtime (discussed further below). In another embodiment, controller 220 may interact with memory 206. In yet another embodiment, controller 220 has access to storage 207 via ICH 208.

Embodiments of Flash memory 214 and/or embodiments of ROM 220C may store instructions substantially in compliance with the Extensible Firmware Interface (EFI) (Extensible Firmware Interface Specification, Version 1.10, Dec. 1, 2002, available at http://developer.intel.com/technology/efi.) EFI enables firmware, in the form of firmware modules and drivers, to be loaded from a variety of different resources, including flash memory devices, option ROMs (Read-Only Memory), other storage devices, such as hard disks, CD-ROM (Compact Disk-Read Only Memory), or from one or more computer systems over a computer network. One embodiment of an implementation of the EFI specification is described in the Intel® Platform Innovation Framework for EFI Architecture Specification—Draft for Review, Version 0.9, Sep. 16, 2003, referred to hereafter as the “Framework” (available at www.intel.com/technology/framework). It will be understood that embodiments of the present invention are not limited to the “Framework” or implementations in compliance with the EFI specification.

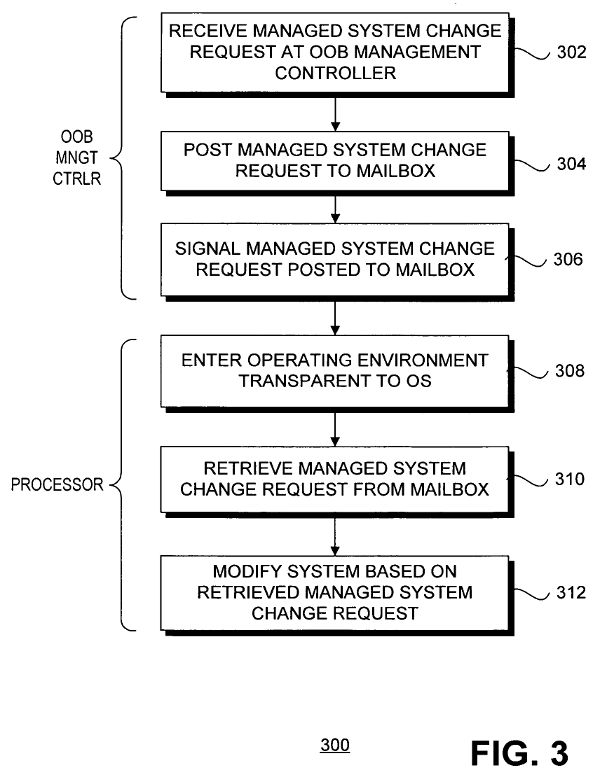

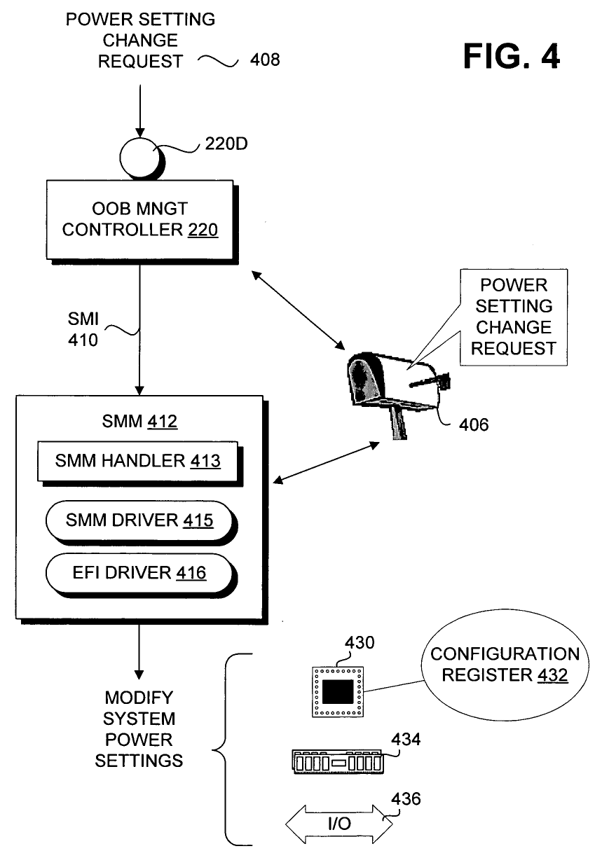

Referring to FIG. 3, a flowchart 300 illustrating an embodiment of the logic and operations to provide an enterprise management policy is shown. Flowchart 300 will be described in conjunction with FIG. 4. FIG. 4 shows an embodiment of an implementation of flowchart 300.

Starting in a block 302, a managed system change request 108 is received at OOB management controller 220 via OOB network I/F 220D. In FIG. 4, the managed system change request includes a power setting change request 408 received at OOB management controller 220.

Proceeding to a block 304, the managed system change request is posted to a mailbox 406. Mailbox 406 includes a repository that OOB management controller 220 and processor 202 may both access. In one embodiment, mailbox 406 includes a Keyboard Controller Style (KCS) Interface. In one embodiment, the KCS Interface is a Systems Management Software (SMS) interface provided by the Baseboard Management Controller (BMC) of the managed system. In this particular embodiment, the KCS Interface may include a pair of Input/Output ports addressed by the System Management BIOS (SMBIOS) tables of the managed system.

In another embodiment, mailbox 406 includes a memory mapped I/O register. This memory mapped I/O register may be used to store a memory address accessible by both the OOB management controller 220 and processor 202. In this particular embodiment, managed system changed request 108 is stored at the memory address.

Continuing to a block 306, the posting of the managed system change request is signaled to processor 202. Proceeding to a block 308, the managed system enters an operating environment that is transparent to the operating system of the managed system. In one embodiment, such an operating environment includes a System Management Mode (SMM).

In the embodiment of FIG. 4, the OOB management controller 220 signals the posting of the power setting change request using an SMI 410. OOB management controller 220 may generate SMI 410 via ICH 208. SMI 410 is received at processor 202 and causes managed system 200 to enter System Management Mode (SMM) 412. In one embodiment, controller 220 sends an SMBUS message to ICH 208 using SMBUS 218 to initiate the SMI. In another embodiment, controller 220 may use PCI bus 212 to set and clear a General Purpose I/O (GPIO) register of ICH 208. In this particular embodiment, the motherboard of system 200 may tie the GPIO pin of ICH 208 to the SMIACT# pin of processor 202.

SMM is a special mode for handling system wide functions and is intended for use only by system firmware, and not by an OS or an application. SMM is an OS-transparent mode of operation and is a distinct operational mode. SMM may be entered during pre-boot as well as OS runtime.

When SMM is invoked through an SMI, the processor saves the current state of the processor and switches to a separate operating environment contained in System Management Random Access Memory (SMRAM). While in SMM, the processor executes an SMI Handler to perform operations. An SMI Handler may call drivers, such as SMM drivers or EFI drivers. In an embodiment using the Framework, the EFI drivers may be considered EFI runtime drivers. When the SMM operations are complete, SMM executes a resume instruction. This instruction causes the processor to reload the saved state of the processor, switch back to protected or real mode, and resume executing the interrupted application or OS tasks.

Embodiments of the present invention may be implemented on a 64-bit processor, such as the Intel® Itanium® family of processors. Itanium® processors employ a Platform Management Interrupt (PMI.) The handling of an SMI with an IA32 processor and a PMI with an Itanium® family processor involve similar processes, as will be appreciated by one of ordinary skill in the art.

While in SMM, the processor executes code and stores data in the SMRAM space. The actual physical location of the SMRAM may be in system memory or in a separate memory device. The processor uses SMRAM to save the state of the processor and to store SMM related code and data. SMRAM may also store system management information and Original Equipment Manufacturer (OEM) specific information.

In one embodiment using EFI, Portable Executable and Common Object File Format (PE/COFF) executable images are used (PE/COFF Specification, Version 6.0, February 1999, available at http://www.microsoft.com/whdc/hwdev/hardware/pecoff.mspx) for various system software components. EFI drivers for providing management policy as described herein may be formed as PE/COFF images to be executed in SMM (discussed further below).

Referring again to FIG. 3, after block 308, the logic proceeds to a block 310 to retrieve the managed system change request from mailbox 406. Continuing to a block 312, system 200 is modified based on the managed system change request. In one embodiment, SMM Handler 413 may be used to affect the management policy using one or more drivers. In one embodiment, the managed system change request may be affected by an SMM driver 415. In another embodiment, the managed system change request may be affected by an EFI driver 416. In one embodiment, the operations of blocks 302, 304, and 306 may be executed by processor 220A of OOB management controller 220 and the operations of blocks 308, 310, and 312 may be executed by processor 202.

In the embodiment of FIG. 4, the power setting change request 408 may modify one or more power settings of managed system 200. Embodiments of such power settings include a processor power setting 430, a memory bus power setting 434, and an input/output bus power setting 436. In one embodiment, modifying the memory bus power setting 434 and/or the I/O bus power setting 436 includes adjusting the data transmission frequencies of the buses, where a lower frequency results in less power consumption. Embodiments herein offer fine-grained control of the power consumption of a managed system. The ability to modify system power settings of a processor, memory bus and I/O bus in any combination gives system administrators a plethora of power management options.

In one embodiment, modifying the processor power setting 430 involves modifying a processor configuration register 432. To save power, a processor's speed and voltage may be lowered. Instead of turning a system completely off, performance may be reduced in order to reduce power consumption. When more performance is needed, the power settings of the processor may be modified accordingly. Embodiments of processor power setting 430 include Intel SpeedStep, Advanced Micro Devices (AMD) PowerNow!, Transmeta LongRun, or the like. Intel SpeedStep is part of Intel's Geyserville Technology.

An embodiment of frequency/voltage settings for an Intel Mobile Pentium III processor with Intel SpeedStep is shown below in Table 1.

TABLE 1

| | | | MAXIMUM POWER |
|---|---|---|---|
| FREQUENCY | | VOLTAGE | CONSUMPTION |
| 600 | MHz | 1.6 V | 20.0 Watts |
| 700 | MHz | 1.6 V | 23.0 Watts |
| 800 | MHz | 1.6 V | 25.9 Watts |
| 900 | MHz | 1.7 V | 30.7 Watts |
| 1 | GHz | 1.7 V | 34.0 Watts |

An embodiment of processor configuration register 432 includes a Model Specific Register (MSR) associated with Intel processors, such as the Pentium family and the Xeon family. MSRs may be used to store processor-related data such as power settings, performance monitoring, run-time machine checks, and memory types for physical memory. MSRs may be read and written to using RDMSR and WRMSR instructions, respectively. In an embodiment of Intel SpeedStep, the processor power settings, commonly referred to as power-states, may be stored in one or more Model Specific Registers. In yet another embodiment, such MSRs may be referred to as Geyserville 3 (GV3) registers for storing power-states.

In one embodiment, instructions to modify a MSR must be executed on the processor associated with the MSR. For example, instructions executed by processor 220A may not modify a MSR of processor 202. Embodiments herein provide for power management policy to be messengered by OOB management controller 220 and to be affected by instructions executing on processor 202.

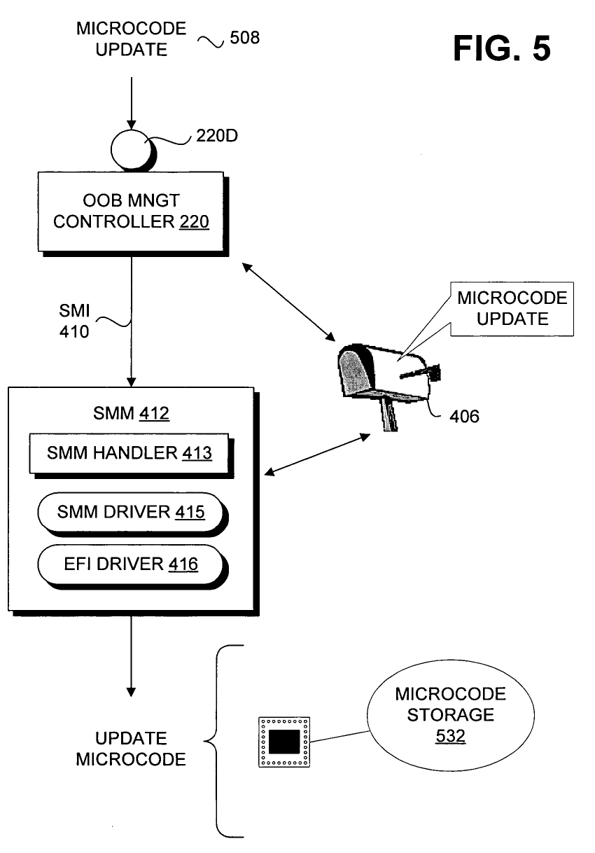

Turning to FIG. 5, an embodiment to modify a managed system using a microcode patch is shown. In FIG. 5, the managed system change request includes a microcode update 508 for processor 202. The microcode update is posted to mailbox 406 and an SMI is initiated by OOB management controller 220. Processor 202 enters SMM and retrieves the microcode update 508. In one embodiment, microcode storage 532 includes Programmable Read-Only Memory (PROM), Erasable Programmable Read-Only Memory (EPROM), or the like. In one embodiment, SMM 412 uses a driver, such as SMM driver 415 or EFI driver 416, to update microcode stored in microcode storage 532. In another embodiment, SMM 412 writes the location of the microcode update 508 to an MSR of processor 202 using a driver. In this particular embodiment, another set of instructions reads the location of the microcode update 508 and performs the update.

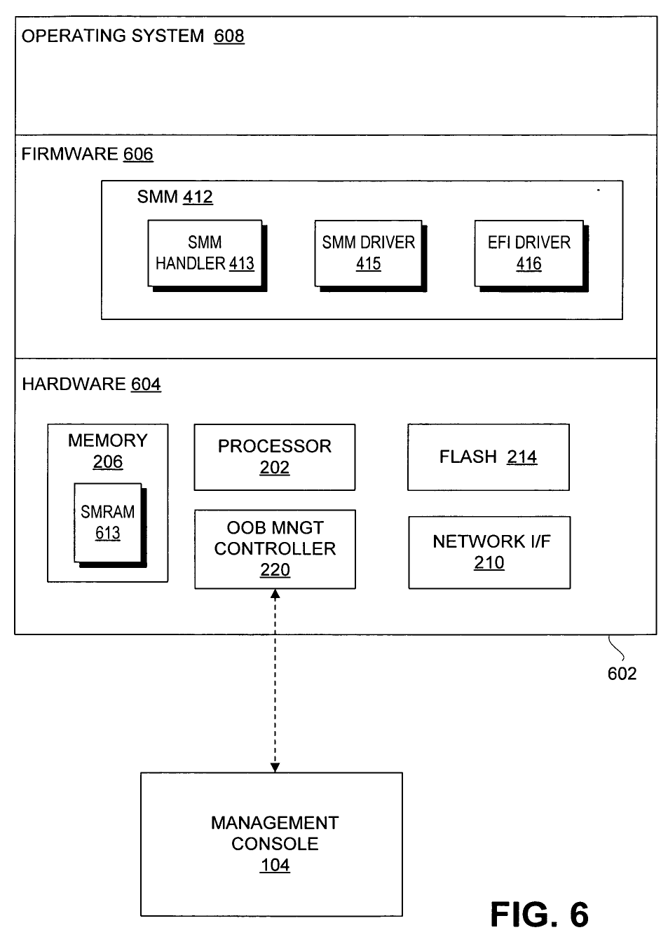

Turning to FIG. 6, an embodiment of an architectural environment of a managed system 602 is shown. Firmware 606 is layered on hardware 604. An operating system 608 is layered on firmware 606. Hardware 604 includes memory 206, processor 202, flash memory 214, OOB management controller 220, and network interface 210. An address space of memory 206 is designated as SMRAM 613. OOB management controller 220 may receive a managed system change request from management console 104.

Firmware 606 includes SMM 412. SMM 412 includes an SMM Handler 413. In one embodiment, SMM Driver 415 is loaded from Flash memory 214 into SMRAM 613 for execution in SMM 412. In another embodiment, EFI Driver 416 is loaded from Flash memory 214 into SMRAM 613 for execution in SMM 412.

It will be understood that receiving and implementing management policy may be achieved without complicity from an OS. Modification of the managed system is conducted at the firmware level and is not reliant on the existence or the state of an OS. Since the management policy may be affected without dependency upon the OS, the policy may be implemented across a variety of platforms in an enterprise network having a variety of operating systems. Moreover, the update or changing of an OS on a particular system does not necessitate the updating or changing of the management policy deployment scheme. Further, a hung or crashed OS does not limit the implementation of a management policy as described herein. Additionally, since embodiments described herein are OS transparent, system settings may be modified during pre-boot as well as OS runtime.

It will also be appreciated that embodiments of the invention may not need cooperation from the Advanced Configuration and Power Interface (ACPI) (Advanced Configuration and Power Interface Specification, version 2.0b, Oct. 11, 2002). ACPI is an industry-standard interface for OS-directed configuration and power management of computer systems, such as laptops, desktops, and servers. One of the goals of ACPI is to support power management from the OS level. OS enhancements are needed to support ACPI-defined features, concepts, and interfaces. Since embodiments herein operate below the OS level, ACPI support is unnecessary.

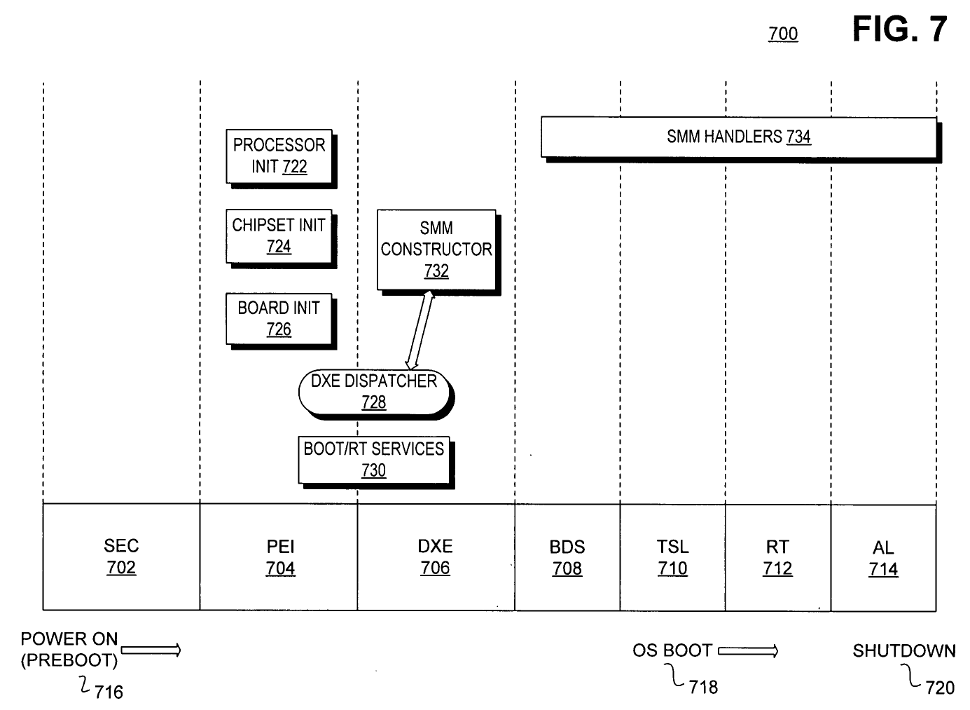

Referring FIG. 7, an event sequence diagram 700 to illustrate an embodiment of operations performed by a computer system according to the Framework is shown. Event sequence diagram 700 is divided into several phases, including a Security (SEC) phase 702, a Pre-EFI Initialization (PEI) phase 704, a Driver Execution Environment (DXE) phase 706, a Boot Device Selection (BDS) phase 708, a Transient System Load (TSL) phase 710, an operating system Run-Time (RT) phase 712, and an After-Life (AL) phase 714. The phases build upon one another to provide an appropriate run-time environment for the OS and platform.

The SEC phase 702 supports security checks of the initial op-code to be executed on the computer system. The SEC phase 702 begins at power-on 716 and includes the power-on sequence of the computer system and authenticates the PEI Foundation before the PEI Foundation is allowed to execute. Power-on 716 also begins the pre-boot phase of the computer system.

The PEI phase 704 provides a standardized method of loading and invoking processor initialization 722, chipset initialization 724, and motherboard initialization 726. The PEI phase is responsible for initializing enough of the system to provide a stable base for the follow on phases. The PEI phase discovers memory and prepares a resource map that is handed off to the DXE phase. The state of the system at the end of the PEI phase is passed to the DXE phase through a list of data structures called Hand Off Blocks (HOBs).

The DXE phase 706 is the phase during which most of the system initialization is performed. The DXE phase 706 is facilitated by several components, including the DXE Dispatcher 728, the DXE Core (not shown), and a set of DXE drivers (not shown). The DXE Core produces a set of Boot and Runtime Services 730. The DXE Dispatcher 728 is responsible for discovering and executing DXE drivers in the correct order. The DXE drivers are responsible for initializing the processor, chipset, and platform components as well as providing software abstractions for boot devices. These components work together to initialize the platform and provide the services required to boot an operating system.

The BDS phase 708 further prepares the computer system to load an operating system. The TSL phase 710 allows services to be available to an OS Loader before the OS is allowed to take control of the computer system. The execution of the OS Loader during TSL 710 begins the OS boot 718. At the RT phase 712, the firmware turns over control of some hardware to the operating system. EFI Runtime services survive into the RT phase 712. In the AL phase 714, the firmware may continue to function after the OS has terminated.

Once initialized into the EFI Framework environment, an EFI driver may be used during SMM by SMM Handlers 734 to modify system settings. The EFI driver may be used during preboot as well as OS runtime. The Framework provides a mechanism to load EFI drivers into SMM. An EFI driver, such as a DXE driver, will reload itself into SMM and rerun its entry point in SMM. Once loaded into SMM, the EFI driver may be assisted by an SMM Constructor 732. The EFI driver may register an interface in a protocol database to name the SMM-resident interfaces to future loaded EFI drivers. The EFI Driver may register with the SMM infrastructure code for a callback response to an SMI-pin activation or an SMI-based message from a boot-service or runtime agent.

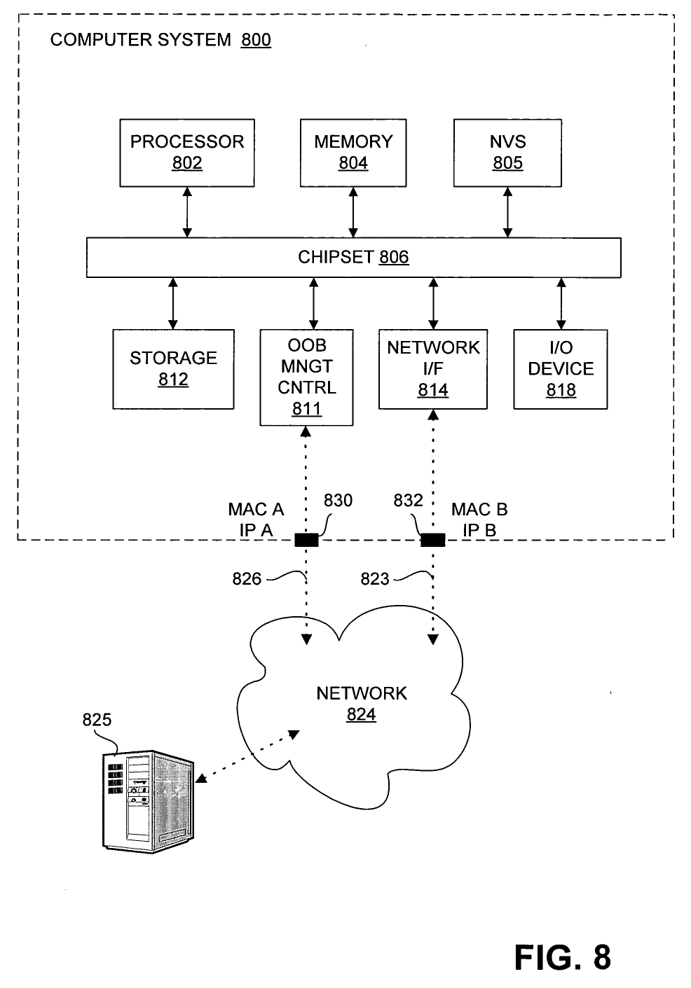

FIG. 8 is an illustration of one embodiment of a computer system 800 to implement embodiments of the invention. Computer system 800 includes a processor 802 and a memory 804 coupled to a chipset 806. Storage 812, non-volatile storage (NVS) 805, network interface 814, and Input/Output (I/O) device 818 may also be coupled to chipset 806. Embodiments of computer system 800 include, but are not limited to, a desktop computer, a notebook computer, a server, a personal digital assistant, a network workstation, or the like. In one embodiment, computer system 800 includes processor 802 coupled to memory 804, processor 802 to execute instructions stored in memory 804.

Processor 802 may include, but is not limited to, an Intel Corporation x86, Pentium®, Xeon®, or Itanium® family processor, a Motorola family processor, or the like. In one embodiment, computer system 800 may include multiple processors. Memory 804 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like.

Chipset 806 may include a Memory Controller Hub (MCH), an Input/Output Controller Hub (ICH), or the like. Chipset 806 may also include a Peripheral Component Interconnect (PCI) bus, a System Management Bus (SMBUS), a Low Pin Count (LPC) bus, a Serial Peripheral Interface (SPI) bus, or the like. I/O device 818 may include a keyboard, a mouse, a display, a printer, a scanner, or the like.

Computer system 800 may interface to external systems through network interface 814. Network interface 814 may include, but is not limited to, a modem, a Network Interface Card (NIC), or other interfaces for coupling a computer system to other computer systems. A carrier wave signal 823 is received/transmitted by network interface 814. In the embodiment illustrated in FIG. 8, carrier wave signal 823 is used to interface computer system 800 with a network 824, such as a Local Area Network (LAN), a Wide Area Network (WAN), the Internet, or any combination thereof. In one embodiment, network 824 is further coupled to a computer system 825 such that computer system 800 and computer system 825 may communicate over network 824.

Computer system 800 may also include an OOB management controller 811 coupled to chipset 806. In one embodiment, controller 811 is an integrated component of chipset 806. Controller 811 may communicate with network 824 using a carrier wave signal 826.

In one embodiment, OOB management controller 811 is coupled to a port 830 having MAC address A and IP address A, and network interface 814 is coupled to a port 832 having MAC address B and IP address B. In this particular embodiment, computer system 800 is viewed by the network 824 as two distinct nodes.

The computer system 800 also includes NVS 805 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like. Storage 812 includes, but is not limited to, a magnetic hard disk, a magnetic tape, an optical disk, or the like. It is appreciated that instructions executable by processor 802 may reside in storage 812, memory 804, NVS 805, controller 811, or may be transmitted or received via network interface 814.

For the purposes of the specification, a machine-accessible medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-accessible medium includes, but is not limited to, recordable/non-recordable media (e.g., Read-Only Memory (ROM), Random Access Memory (RAM), magnetic disk storage media, optical storage media, a flash memory device, etc.). In addition, a machine-accessible medium may include propagated signals such as electrical, optical, acoustical or other form of propagated signals (e.g., carrier waves, infrared signals, digital signals, etc.).

It will be appreciated that in one embodiment, computer system 800 may execute operating system software. For example, one embodiment of the present invention utilizes Microsoft Windows® as the operating system for computer system 800. Other operating systems that may also be used with computer system 800 include, but are not limited to, the Apple Macintosh operating system, the Linux operating system, the Unix operating system, or the like.

Embodiments of various operations of the present invention are described herein. These operations may be implemented by a machine using a processor, an Application Specific Integrated Circuit (ASIC), a Field Programmable Gate Array (FPGA), or the like. In one embodiment, one or more of the operations described may constitute instructions stored on a machine-accessible medium, that when executed by a machine will cause the machine to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
receiving a managed system change request at an out-of-band management controller of a computer system;
posting the managed system change request to a mailbox;
signaling the managed system change request has been posted to the mailbox; and
modifying the computer system based on the managed system change request without complicity from an operating system of the computer system.

2. The method of claim 1 wherein the mailbox includes at least one of a Keyboard Controller Style (KCS) Interface of the computer system and a memory mapped input/output register of the computer system.

3. The method of claim 1 wherein signaling the managed system change request has been posted to the mailbox includes generating a System Management Interrupt (SMI).

4. The method of claim 1, further comprising entering an operating environment that is transparent to the operating system.

5. The method of claim 4 wherein the operating environment includes a System Management Mode (SMM).

6. The method of claim 1 wherein modifying the computer system includes modifying a power setting of the computer system.

7. The method of claim 6 wherein the power setting includes at least one of a processor power setting, an input/output bus power setting, and a memory bus power setting.

8. The method of claim 7 wherein the processor power setting is stored in a configuration register of the processor.

9. The method of claim 1 wherein modifying the computer system includes updating microcode of a processor of the computer system.

10. An article of manufacture comprising:
a machine-accessible medium including a plurality of instructions which when executed perform operations comprising:
receiving a managed system change request at an out-of-band management controller of a computer system;
posting the managed system change request to a mailbox;
signaling the managed system change request has been posted to the mailbox;
retrieving the managed system change request during a system management operating environment, wherein the system management operating environment is transparent to an operating system of the computer system; and
modifying the computer system while in the system management operating environment based on the managed system change request.

11. The article of manufacture of claim 10 wherein signaling the managed system change request has been posted to the mailbox includes generating a System Management Interrupt (SMI).

12. The article of manufacture of claim 10 wherein the system management operating environment includes a System Management Mode (SMM).

13. The article of manufacture of claim 10 wherein modifying the computer system includes updating the microcode of a processor of the computer system.

14. The article of manufacture of claim 10 wherein modifying the computer system includes modifying a power setting of the computer system.

15. The article of manufacture of claim 14 wherein the power setting includes at least one of a processor power setting, an input/output bus power setting, and a memory bus power setting.

16. The article of manufacture of claim 15 wherein the processor power setting is stored in a Model Specific Register (MSR) of the processor.

17. The article of manufacture of claim 10 wherein the mailbox includes at least one of a Keyboard Controller Style (KCS) Interface of the computer system and a memory mapped input/output register of the computer system.

18. A system, comprising:
a processor;
an Synchronized Dynamic Random Access Memory (SDRAM) unit coupled to the processor;
a chipset coupled to the processor, the chipset including an out-of-band management controller; and
at least one storage unit coupled to the chipset, the at least one storage unit having stored a plurality of instructions which when executed perform operations comprising:
receiving a managed system change request at the out-of-band management controller;
posting the managed system change request to a mailbox by the out-of-band management controller;
initiating a System Management Interrupt (SMI) by the out-of-band management controller to signal that the managed system change request has been posted to the mailbox;
entering a System Management Mode (SMM) of the processor, wherein the SMM is executed in a System Management Random Access Memory (SMRAM) address space of the SDRAM unit;
retrieving the managed system change request from the mailbox during the SMM by the processor; and
modifying the computer system during the SMM by the processor based on the managed system change request.

19. The system of claim 18, further comprising a management console communicatively coupled to the out-of-band management controller, the management console to generate the managed system change request.

20. The system of claim 19 wherein the out-of-band management controller further comprises an out-of-band network interface, the management console to send the managed system change request to a network address associated with the out-of-band network interface.
